(19) United States
(12) Patent Application Publication
(10) Pub. No.: US 2015/0271044 A1
(43) Pub. Date: Sep. 24, 2015

(54) BROWSER RESPONSE OPTIMIZATION

(71) Applicant: International Business Machines Corporation, Armonk, NY (US)

(72) Inventors: Swaminathan Balasubramanian, Southfield, MI (US); Ravi P. Bansal, Tampa, FL (US); Radha M. De, Howrah (IN)

(73) Assignee: International Business Machines Corporation, Armonk, NY (US)

(21) Appl. No.: 14/223,066

(22) Filed: Mar. 24, 2014

(51) Int. Cl. H04L 12/26; H04L 29/06

(52) U.S. Cl. CPC H04L 43/0882; H04L 67/42

(57) ABSTRACT

An approach for browser response optimization is provided. A web server determines whether workload on the web server is below a threshold, in response to receiving a request from a client. The web server sends to the client an intermediate response which includes code for evaluating a capacity of the client, in response to determining that the workload is not below the threshold. The web server receives a result of executing the code by the client, wherein the result includes data of metrics of the client. The web server determines whether the client is capable of handling a partial response, by comparing the metrics to predetermined benchmarks. In response to determining that the client is capable of handling the partial response, the web server builds and sends to the client a partial response which is for the client to compile and render on the client.

### TECHNICAL FIELD OF THE INVENTION

The present invention relates generally to a server-client system, and more particularly browser response optimization.

### BACKGROUND

A web server typically aggregates content from discrete data sources into a response that is sent back to a requesting client. The client renders the response by executing code, such as JavaScript functions, which is contained in the response. Execution of the code may modify the structure/content of the response, such as the response DOM (Document Object Model) tree; therefore, the rendered response is very different from what has been returned by the server.

Presently, in situations where the client executes the code contained in the response before rendering, the user perceives a delay in receiving the response. Depending on how the execution is, this delay may be perceptively large. The delay may be larger if the client resources are already stretched due to other application processing. Even when the server has capacity, it is unable to handle some of this computation because the server has already committed the response.

### SUMMARY

In one aspect, a computer-implemented method for browser response optimization is provided. The computer-implemented method comprises: determining whether workload on a web server is below a threshold, in response to receiving a request from a client; sending an intermediate response to the client, in response to determining that the workload on the web server is not below the threshold. The intermediate response includes code for evaluating a capacity of the client. The computer-implemented method on the web server further comprises: receiving a result of executing the code by the client, wherein the result includes data of metrics of the client; determining whether the client is capable of handling a partial response, by comparing the metrics to predetermined benchmarks; building the partial response, in response to determining that the client is capable of handling the partial response; and sending the partial response to the client. The partial response is for the client to process and render on the client.

In another aspect, a computer program product for browser response optimization is provided. The computer program product comprises a computer readable storage medium on a web server having program code embodied therewith. The program code is executable to: determine whether workload on the web server is below a threshold, in response to receiving a request from a client; send to the client an intermediate response which includes code for evaluating a capacity of the client, in response to determining that the workload on the web server is not below the threshold; receive from the client a result of executing the code by the client, wherein the result includes data of metrics of the client; determine whether the client is capable of handling a partial response, by comparing the metrics to predetermined benchmarks; build the partial response, in response to determining that the client is capable of handling the partial response; and send the partial response to the client. The partial response is for the client to process and render on the client.

In yet another aspect, a computer system for browser response optimization is provided. The computer system comprises one or more processors, one or more computer-readable tangible storage devices, and program instructions stored on at least one of the one or more computer-readable tangible storage devices for execution by at least one of the one or more processors. The program instructions are executable to: determine whether workload on a web server is below a threshold, in response to receiving a request from a client; send to the client an intermediate response which includes code for evaluating a capacity of the client, in response to determining that the workload on the web server is not below the threshold; receive from the client a result of executing the code by the client, wherein the result includes data of metrics of the client; determine whether the client is capable of handling a partial response, by comparing the metrics to predetermined benchmarks; build the partial response, in response to determining that the client is capable of handling the partial response; and send the partial response to the client. The partial response is for the client to process and render on the client.

### BRIEF DESCRIPTION OF THE SEVERAL VIEWS OF THE DRAWINGS

FIG. 1 is a diagram illustrating a system for browser response optimization, in accordance with one embodiment of the present invention.

FIG. 2 (including FIG. 2A and FIG. 2B) is a flowchart illustrating operating steps for browser response optimization, in accordance with one embodiment of the present invention.

FIG. 3 is a diagram illustrating components of a computer system of a web server or a client device shown in FIG. 1, in accordance with one embodiment of the present invention.

### DETAILED DESCRIPTION

An approach disclosed in the embodiments of the present invention optimizes a browser response from a server to a client. The approach determines the optimum response based on either real-time or historic workload of the client, when a request made by the client for content is received by the server. The server determines whether server's workload is below a predetermined threshold. The server builds the complete response to be returned to the client, if the server determines that the server's workload is below the predetermined threshold. If the server determines that the workload exceeds the predetermined threshold, the server determines the workload on the requesting client using either a real-time measurement or historic data. Based on the determination of the workload on the requesting client, the server returns either a complete or a partial response. The complete response is fully processed by the web server and sent from the web server to the requesting client; therefore, the requesting client can directly render the response without processing on the client side. The partial response built by the web server contains content and code. After receiving the partial response from the web server, the requesting client executes, on the client device, the code in the partial response while rendering the content.

The approach disclosed in embodiments of the present invention has at least the following advantages. (1) By changing server response based on real-time client workload, responsiveness of the site or application is greatly improved. (2) The approach disclosed in embodiments of the present invention enables dynamic performance tuning of web applications with varying load on server and client side. (3) The approach disclosed in embodiments of the present invention increases server response capacity during peak hours to generate optimum responses.

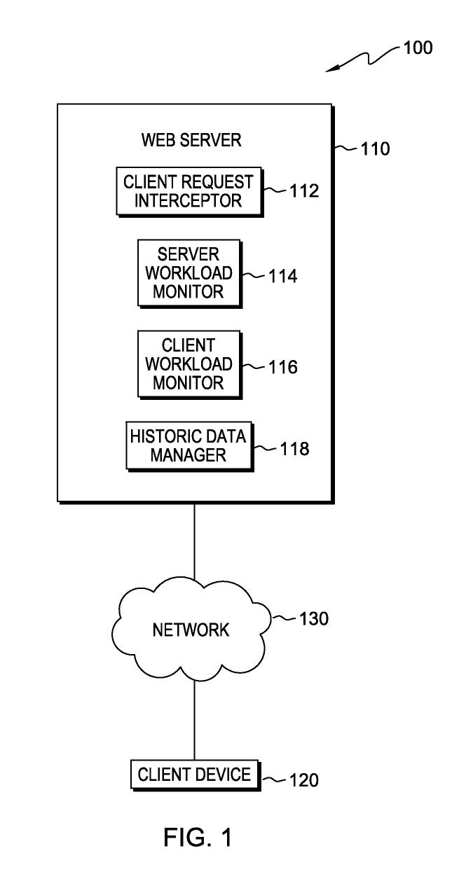

FIG. 1 is a diagram illustrating system 100 for browser response optimization, in accordance with one embodiment of the present invention. System 100 for browser response optimization comprises web server 110 and client device 120 both connected by network 130. Web server 110 comprises client request interceptor 112, server workload monitor 114, client workload monitor 116, and historic data manager 118.

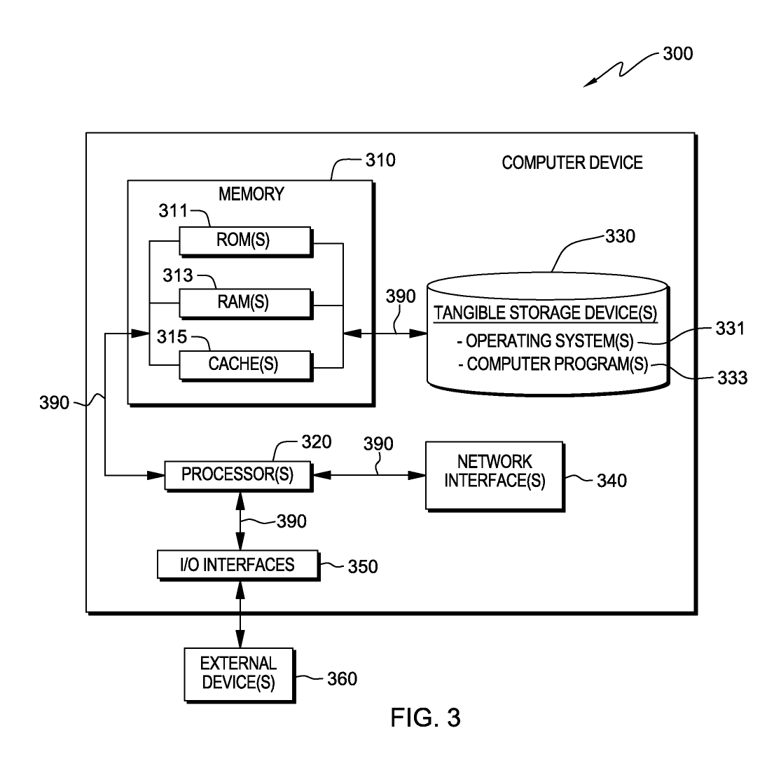

Referring to FIG. 1, web server 110 is a computing system capable of receiving and sending data to and from client device 120 via network 130. Web server 110 is described in more detail in later paragraphs with reference to FIG. 3. Although not shown, optionally, web server 110 may comprise a cluster of web servers executing the same software to collectively process the requests for the web pages as distributed by a front end server and a load balancer.

Referring to FIG. 1, client device 120 may be a desktop computer, a notebook computer, a laptop computer, a tablet computer, a handheld device, a smartphone, a thin client, or any other electronic device or computing system capable of receiving input from a user, executing computer program instructions, and communicating with another computing system via network 130. In general, client computer device 120 is any programmable device that includes a network interface that allows for network connectivity, a display device, a tangible storage device, and a user interface that allows for selection of text and other elements displayed on a display device. Client device 120 is described in more detail in later paragraphs with reference to FIG. 3.

Referring to FIG. 1, network 130 may be the Internet which represents a worldwide collection of networks and gateways to support communications between devices connected to the Internet. Network 130 may be implemented as an intranet, a local area network (LAN), or a wide area network (WAN). Network 130 may include, for example, wired, wireless, or fiber optic connections. In general, network 130 can be any combination of connections and protocols which support communications between client device 120 and web server 110.

Referring to FIG. 1, client request interceptor 112 intercepts a request to web server 110 from client 120, and it invokes server workload monitor 114. Server workload monitor 114 checks workload on web server 110 using known methods and compares with a predetermined threshold of computing capacity on web server 110. If workload on web server 110 appears below the threshold, client request interceptor 112 advises web server 110 to opt for a complete response (such as static HTML); if workload on web server 110 does not appear below the threshold, client request interceptor 112 invokes client workload monitor 116 to verify the capacity of client device 120 to handle a partial response. If client workload monitor 116 finds the capacity of client device 120 as fit to deal with the partial response, client workload monitor 116 advises web server 110 to send the partial response to client device 120. The complete response is fully processed by web server 110 and is then sent from web server 110 to client device 120 through network 130. Client device 120 renders the complete response without executing code. The partial response is built by web server 110, and it contains content and code. Client device 120 receives the partial response from web server 110, and processes the code and the content in the partial response to create the complete response. Then, client 120 renders the complete response that has been created on client device 120.

Referring to FIG. 1, server workload monitor 114 maintains data of workload of web server 110 for different time periods of the day as a predetermined threshold. Once client request interceptor 112 calls server workload monitor 114, client request interceptor 112 compares real-time workload of web server 110 against the predetermined threshold. If the real-time workload of web server 110 appears above the predetermined threshold, client request interceptor 112 advises web server 110 to send a partial response (including mixed content and code) to client device 120. Server workload monitor 114 keeps the workload information of web server 110 in tables such as Table 1. Finally, server workload monitor 114 calls historic data manager 118 to record current workload information of web server 110 for future reference as historic data.

TABLE 1

| | | Requests | Latency | Throughput |
|---|---|---|---|---|
| | Time Period | Handling per | Response | in Bytes |
| ID | (UTC) | Second | (Milliseconds) | per Second |
| 1 | 12 AM-5:59 AM | 30 | 25 | 5000 |
| 2 | 6 AM-11:59 PM | 25 | 20 | 4500 |
| 3 | 12 PM-1:59 PM | 20 | 20 | 3000 |
| 4 | 2 PM-2:59 PM | 15 | 15 | 3500 |
| 5 | 3 PM-3:59 PM | 18 | 15 | 3000 |
| 6 | 4 PM-4:59 PM | 20 | 16 | 2500 |
| 7 | 5 PM-5:59 PM | 20 | 17 | 2500 |
| 8 | 6 PM-11:59 PM | 30 | 20 | 1000 |

Referring to FIG. 1, client workload monitor 116 sends to client device 120 an intermediary response. The intermediary response is used for evaluating the capacity of client device 120 to handle the partial response. Client device 120 executes the intermediary response and calls back web server 110 with an executed result. In an embodiment, client workload monitor 116 then checks the time spent for executing the intermediary response on client device 120. If the time spent appears above a benchmark value, it is indicated that client device 120 does not have the capability to handle a partial response; therefore, client workload monitor 116 advises client request interceptor 112 to prompt web server 110 to send a complete response (such as static HTML) to client device 120. If the time spent is below a benchmark value, it is indicated that client device 120 has the capability to handle a partial response; therefore, client workload monitor 116 advises web server 110 to send the partial response to client device 120. Table 2 shows an example of benchmark values for client workload, in which the benchmark values are maintained with a tabular format. Finally, client workload monitor 116 calls historic data manager 118 to record current client workload metrics (such as operation system version, device battery charge, network bandwidth of client device 120) for future use as historic data.

TABLE 2

| | | | Execution Time |
|---|---|---|---|
| Test | Operating System | Browser | (seconds) |
| Speed Test | Windows XP | IE 7.x | 0.130 |
| | Windows XP | IE 8.x | 0.120 |
| | Mac | Opera 7x | 0.120 |
| | Windows XP | Google Chrome 5x | 0.110 |

Referring to FIG. 1, historic data manager 118 maintains client specific information about past response determinations. A set of keys to identify client device 120 may include a unique ID assigned by web server 110 to client device 120, timestamps, client location data (such as location coordinates), and client device and client device power management data. If the set of keys in a future request matches this historic data, historic data manager 118 reuses the previous response determination to handle the new request.

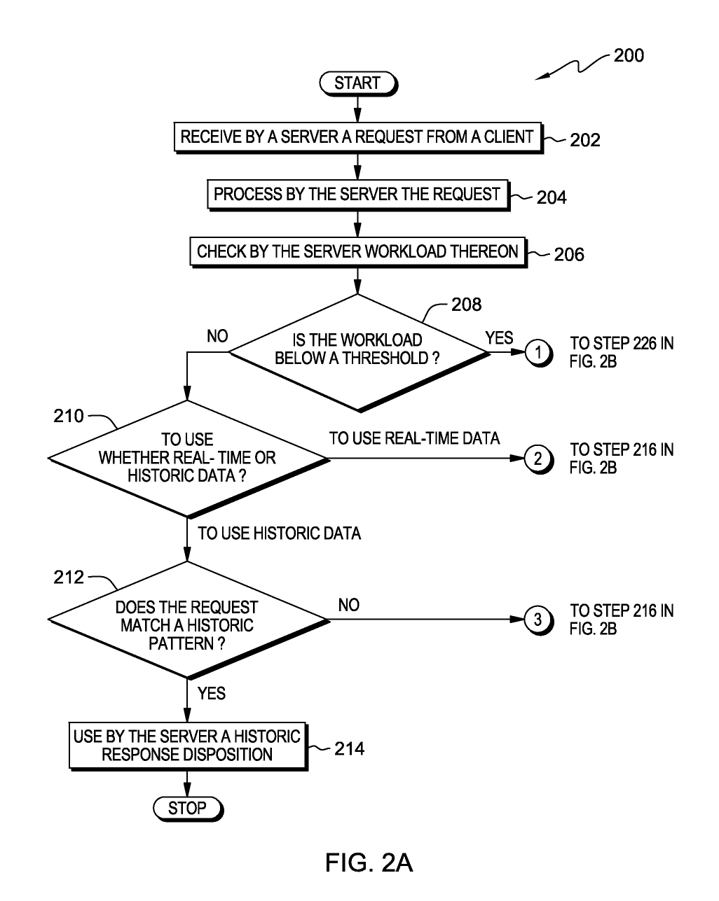

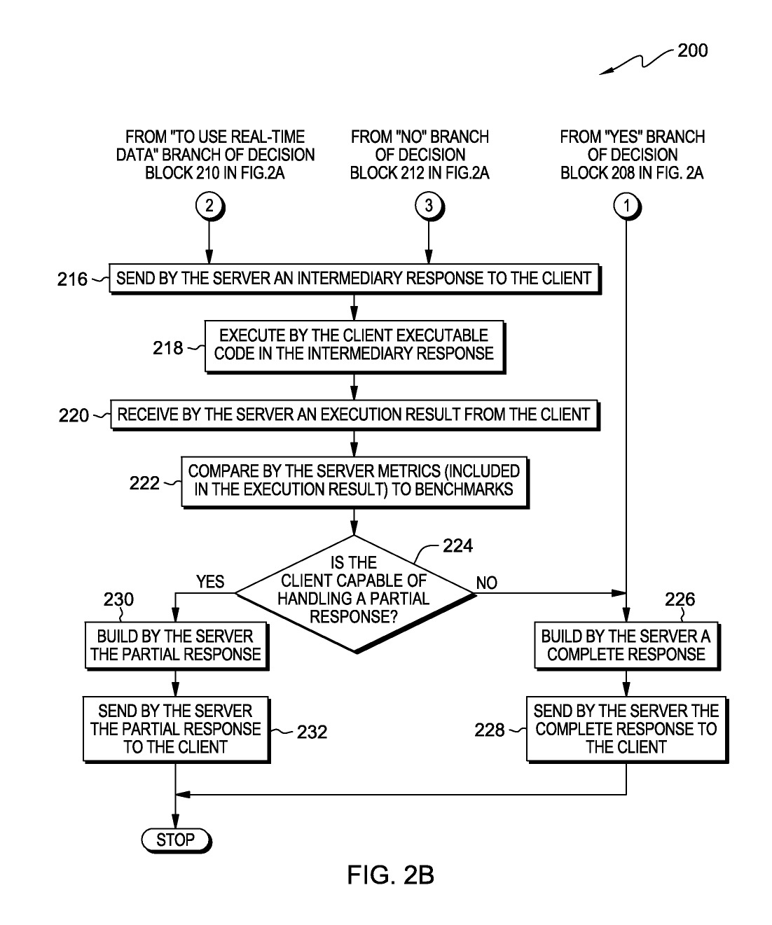

FIG. 2 (including FIG. 2A and FIG. 2B) is flowchart 200 illustrating operating steps for browser response optimization, in accordance with one embodiment of the present invention. FIG. 2A and FIG. 2B show complete steps of flowchart 200.

Referring to FIG. 2A, at step 202, web server 110 (shown in FIG. 1) receives from client device 120 (shown in FIG. 1) a request for a web page. The request is sent form client device 120 to web server 110 through network 130 (shown in FIG. 1). At step 204, web server 110 processes the request received at step 202. At step 206, web server 110 checks workload on the web server. When web server 110 is ready to return a response to the request, the web server first looks at the current workload on the web server. At decision block 208, web server 110 determines whether the workload on the web server is below a predetermined threshold. The predetermined threshold is a computing capacity of web server 110. For example, 80% of memory usage of web server 110 is set as the predetermined threshold.

In response to determining that the workload is below the predetermined threshold (YES branch of decision block 208 shown in FIG. 2A), web server 110 processes steps 226 and 228 shown in FIG. 2B. At step 226, web server 110 builds a complete response, which is fully processed by web server 110 and rendered by client device 120 without executing code. At step 228, web server 110 sends the complete response to client device 110 through network 130. In response to determining that the workload is not below the predetermined threshold (NO branch of decision block 208), web server 110 at decision block 210 determines whether real-time or historic data is used. Web server 110 checks whether sufficient historic data exists. For example, if data of more than three previous request-response sessions is stored, web server 110 determines that sufficient data exists. If the sufficient historic data exists, web server 110 determines that the historic data is used; otherwise, web server 110 determines that the real-time data is used.

In response to determining that the real-time data is used (TO USE REAL-TIME DATA branch of decision block 210), web server 110 processes step 216 shown in FIG. 2B. In response to determining that the historic data is used (TO USE HISTORIC DATA branch of decision block 210), web server 110 at decision block 212 determines whether the request received at step 202 matches a historic pattern. The historic pattern is retrieved from historic data manager 118 which maintains information of past response determinations for client device 110.

In response to determining that the request does not match the historic pattern (NO branch of decision block 212 shown in FIG. 2A), web server 110 processes step 216 shown in FIG. 2B. Step 216 is discussed in a later paragraph of this document. In response to determining that the request matches the historic pattern (YES branch of decision block 212), web server 110 at step 214 uses a historic response disposition.

Referring to FIG. 2B, in response to determining that the real-time data is used (TO USE HISTORIC DATA branch of decision block 210 shown in FIG. 2A) or in response to determining that the request does not match a historic pattern (NO branch of decision block 212 shown in FIG. 2A), at step 216, web server 110 sends an intermediary response to client device 120. The intermediary response contains a piece of executable code (such as JavaScript) that runs on client device 120, and the intermediate response is used for evaluating the capacity of client device 120 to handle a partial response. The partial response is built by web server 110 and it contains content and code. The code is executed by client device 120 while rending the partial response.

At step 218, client device 120 executes the executable code in the intermediary response. At step 220, web server 110 receives a result of executing the executable code in the intermediate response. The result contains data of metrics of client device 120. For example, the metrics may include a browser version, an operating system version, device battery charge, network bandwidth of client device 120. In another embodiment, upon receiving the result from client device 120, web server 110 records the metrics as the historic data.

At step 222, web server 110 compares the metrics to benchmarks. The benchmarks are standards of performance of client devices. Based on the comparison made at step 222, at decision block 224, web server 110 determines whether client device 120 is capable of handling a partial response. In an example, if the time spent for executing the intermediary response on client device 120 is not above a benchmark value, then web server 110 determines that client device 120 is capable of handling a partial response. In another example, if the operating system of client device 120 is above the benchmark, then web server 110 determines that client device 120 is capable of handling a partial response.

In response to determining that client device 120 is not capable of handling the partial response (NO branch of decision block 224), web server 110 at step 226 builds the complete response and then at step 228 sends the complete response to client device 120. In response to determining that client device 120 is capable of handling the partial response (YES branch of decision block 224), web server 110 at step 230 builds the partial response and then at step 232 sends the partial response to client device 120.

In another embodiment, after either step 228 or step 232, web server 110 stores a record of this request-response session on client device 120. The record is stored as the historic data that is used to analyze the historic pattern at decision block 212 and to determine the historic response disposition at step 214.

FIG. 3 is a diagram illustrating components of computer system 300 of web server 110 or client device 120 shown in FIG. 1, in accordance with one embodiment of the present invention. It should be appreciated that FIG. 3 provides only an illustration of one implementation and does not imply any limitations with regard to the environment in which different embodiments may be implemented. In other embodiments, web server 110 may be hosted by multiple computer devices which are connected by a network.

Referring to FIG. 3, computing device 300 includes processor(s) 320, memory 310, tangible storage device(s) 330, network interface(s) 340, and I/O (input/output) interface(s) 350. In FIG. 3, communications among the above-mentioned components of computing device 300 are denoted by numeral 390. Memory 310 includes ROM(s) (Read Only Memory) 311, RAM(s) (Random Access Memory) 313, and cache(s) 315.

One or more operating systems 331 and one or more computer programs 333 reside on one or more computer-readable tangible storage device(s) 330. In accordance with one embodiment of the present invention, client request interceptor 112, server workload monitor 114, client workload monitor 116, and historic data manager 118 reside on at least one of one or more computer-readable tangible storage device(s) 330.

Computing device 300 further includes I/O interface(s) 350. I/O interface(s) 350 allow for input and output of data with external device(s) 360 that may be connected to computing device 300. Computing device 300 further includes network interface(s) 340 for communications between computing device 300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for browser response optimization, the method comprising:
determining, by a web server, whether workload on the web server is below a threshold, in response to receiving a request from a client;
sending, by the web server, an intermediate response to the client, in response to determining that the workload on the web server is not below the threshold, wherein the intermediate response includes code for evaluating a capacity of the client;
receiving from the client, by the web server, a result of executing the code by the client, wherein the result includes data of metrics of the client;
determining whether the client is capable of handling a partial response, by comparing the metrics to predetermined benchmarks;
building, by the web server, the partial response, in response to determining that the client is capable of handling the partial response, wherein the partial response is for the client to process and render on the client; and
sending, by the web server, the partial response to the client.

2. The computer-implemented method of claim 1, further comprising:
building, by the web server, a complete response, in response to determining that the client is not capable of handling the partial response, wherein the complete response is processed on the web server; and
sending, by the web server, the complete response to the client.

3. The computer-implemented method of claim 1, further comprising:
building, by the web server, a complete response, in response to determining that the workload on the web server is below the threshold, wherein the complete response is processed on the web server; and
sending, by the web server, the complete response to the client.

4. The computer-implemented method of claim 1, further comprising:
determining, by the web server, whether historic data or real-time data is used; and
sending, by the web server, the intermediate response to the client, in response to determining that the real-time data is used.

5. The computer-implemented method of claim 4, further comprising:
determining, by the web server, whether the request matches a historic pattern, in response to determining that the historic data is used; and
using, by the web server, a historic response disposition, in determining that the request matches the historic pattern.

6. The computer-implemented method of claim 5, further comprising:
sending, by the web server, the intermediate response to the client, in response to determining that the request does not match the historic pattern.

7. A computer program product for browser response optimization, the computer program product comprising a computer readable storage medium having program code embodied therewith, the program code executable to:
determine, by a web server, whether workload on the web server is below a threshold, in response to receiving a request from a client;
send, by the web server, an intermediate response to the client, in response to determining that the workload on the web server is not below the threshold, wherein the intermediate response includes code for evaluating a capacity of the client;
receive from the client, by the web server, a result of executing the code by the client, wherein the result includes data of metrics of the client;
determine whether the client is capable of handling a partial response, by comparing the metrics to predetermined benchmarks;
build, by the web server, the partial response, in response to determining that the client is capable of handling the partial response, wherein the partial response is for the client to process and render on the client; and
send, by the web server, the partial response to the client.

8. The computer program product of claim 7, further comprising the program code executable to:
build, by the web server, a complete response, in response to determining that the client is not capable of handling the partial response, wherein the complete response is processed on the web server; and
send, by the web server, the complete response to the client.

9. The computer program product of claim 7, further comprising the program code executable to:
build, by the web server, a complete response, in response to determining that the workload on the web server is below the threshold, wherein the complete response is processed on the web server; and
send, by the web server, the complete response to the client.

10. The computer program product of claim 7, further comprising the program code executable to:
determine, by the web server, whether historic data or real-time data is used; and
send, by the web server, the intermediate response to the client, in response to determining that the real-time data is used.

11. The computer program product of claim 10, further comprising the program code executable to:
determine, by the web server, whether the request matches a historic pattern, in response to determining that the historic data is used; and
use, by the web server, a historic response disposition, in determining that the request matches the historic pattern.

12. The computer program product of claim 11, further comprising the program code executable to:
send, by the web server, the intermediate response to the client, in response to determining that the request does not match the historic pattern.

13. A computer system for browser response optimization, the computer system comprising:
one or more processors, one or more computer-readable tangible storage devices, and program instructions stored on at least one of the one or more computer-readable tangible storage devices for execution by at least one of the one or more processors, the program instructions executable to:
determine, by a web server, whether workload on the web server is below a threshold, in response to receiving a request from a client;
send, by the web server, an intermediate response to the client, in response to determining that the workload on the web server is not below the threshold, wherein the intermediate response includes code for evaluating a capacity of the client;
receive from the client, by the web server, a result of executing the code by the client, wherein the result includes data of metrics of the client;
determine whether the client is capable of handling a partial response, by comparing the metrics to predetermined benchmarks;
build, by the web server, the partial response, in response to determining that the client is capable of handling the partial response, wherein the partial response is for the client to process and render on the client; and
send, by the web server, the partial response to the client.

14. The computer system of claim 13, further comprising the program instructions executable to:
build, by the web server, a complete response, in response to determining the client is not capable of handling the partial response, wherein the complete response is processed on the web server; and
send, by the web server, the complete response to the client.

15. The computer system of claim 14, further comprising the program instructions executable to:
build, by the web server, a complete response, in response to determining that the workload on the web server is below the threshold, wherein the complete response is processed on the web server; and
send, by the web server, the complete response to the client.

16. The computer system of claim 14, further comprising the program instructions executable to:
determine, by the web server, whether historic data or real-time data is used; and
send, by the web server, the intermediate response to the client, in response to determining that the real-time data is used.

17. The computer system of claim 16, further comprising the program instructions executable to:
determine, by the web server, whether the request matches a historic pattern, in response to determining that the historic data is used; and
use, by the web server, a historic response disposition, in determining that the request matches the historic pattern.

18. The computer system of claim 17, further comprising the program instructions executable to:
send, by the web server, the intermediate response to the client, in response to determining that the request does not match the historic pattern.
